(19) United States
(12) Patent Application Publication
(10) Pub. No.: US 2026/0354489 A1
(43) Pub. Date: Nov. 12, 2026

(54) METHOD AND APPARATUS FOR COUNTING NUMBER OF PUFFS, AND AEROSOL GENERATING DEVICE

(71) Applicant: SHENZHEN FIRST UNION TECHNOLOGY CO., LTD., Shenzhen, Guangdong (CN)

(72) Inventors: Jun ZHANG, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/487,180

(22) PCT Filed: May 20, 2024
(86) PCT No.: PCT/CN2024/094234

§ 371 Date: Nov. 24, 2025

(30) Foreign Application Priority Data
May 31, 2023 (CN) 202310634492.9

(51) Int. Cl. A24F 40/53; A24F 40/57; H05B 1/02; H05B 3/00

(52) U.S. Cl. CPC A24F 40/53; A24F 40/57; H05B 1/0202; H05B 3/0019

(57) ABSTRACT

A method and apparatus for counting the number of puffs, and an aerosol generating device. The method includes the following operations. A measurement value of a target parameter of the aerosol generating device is obtained. The measurement value and a target value of the target parameter is amplified. Duty cycle data of the aerosol generating device is determined based on an amplified measurement value and an amplified target value. A real-time value and a current average value of the duty cycle data is obtained. A change in the number of puffs is determined based on the real-time value and the average value.

### CROSS-REFERENCE TO RELATED APPLICATIONS

This application claims priority to Chinese Patent Application No. 202310634492.9, filed with the China National Intellectual Property Administration on May 31, 2023 and entitled “METHOD AND APPARATUS FOR COUNTING NUMBER OF PUFFS, AND AEROSOL GENERATING DEVICE”, which is incorporated herein by reference in its entirety.

### TECHNOLOGY FIELD

This application relates to the field of aerosol technologies, and in particular, to a method and an apparatus for counting a number of puffs, and an aerosol generating device.

### BACKGROUND

In an e-cigarette product, effective ingredients and aromatic compounds of a cartridge are limited. With an increase in a number of puffs and duration, vapor and aroma are increasingly bland. Advantages such as reducing an outer surface temperature of a device, improving user experience of each cartridge, and endurance of the device can be achieved by limiting a number of puffs of a cigarette.

Currently, in a conventional solution for counting the number of puffs, a pressure-flow senor, a temperature-sensitive sensor, or a microphone switch, for example, a pressure senor, an airflow senor, an NTC senor, or a microphone, is generally added to an air channel. When a user has a puff action, the puff action can be directly detected. However, the solution increases hardware costs of components.

### SUMMARY

Embodiments of this application is intended to provide a method and an apparatus for counting a number of puffs, and an aerosol generating device, which can accurately count the number of puffs of the aerosol generating device.

To resolve the foregoing technical problems, the embodiments of this application provide the following technical solutions.

According to a first aspect, an embodiment of this application provides a method for counting a number of puffs. The method is applied to an aerosol generating device, and includes:
obtaining a measurement value of a target parameter of the aerosol generating device;
amplifying the measurement value and a target value of the target parameter;
determining duty cycle data of the aerosol generating device based on an amplified measurement value and an amplified target value;
obtaining a real-time value and a current average value of the duty cycle data; and
determining a change in the number of puffs based on the real-time value and the average value.

In some embodiments, the determining a change in the number of puffs based on the real-time value and the average value includes:
obtaining a first difference between the real-time value and the average value, and if an absolute value of the first difference is greater than a first preset threshold, increasing the number of puffs of the aerosol generating device by one.

In some embodiments, the determining duty cycle data of the aerosol generating device based on an amplified measurement value and an amplified target value includes:
obtaining a second difference between the amplified measurement value and the amplified target value; and
performing incremental PID operation on the second difference to obtain the duty cycle data.

In some embodiments, the method further includes:
determining whether data in a preset buffer storing the duty cycle data is full; and
if yes, determining the current average value based on the duty cycle data in the preset buffer, and clearing the data in the preset buffer; or
if no, continuing to store the real-time value of the duty cycle data into the preset buffer. In some embodiments, the determining the current average value based on the duty cycle data in the preset buffer includes:
performing median filtering on the duty cycle data; and
updating an average value of filtered duty cycle data to the current average value.

In some embodiments, after the increasing the number of puffs of the aerosol generating device by one, the method further includes:
synchronizing the average value and the real-time value for a first preset duration; and
jumping to the step of determining whether data in a preset buffer storing the duty cycle data is full.

In some embodiments, an update frequency of the average value is less than an update frequency of the real-time value.

In some embodiments, when the absolute value of the first difference is greater than the first preset threshold, the method further includes:
continuously obtaining first differences, and counting a number of times for which absolute values of the first differences are greater than the first preset threshold; and
if the number of times is greater than a second preset threshold, increasing the number of puffs of the aerosol generating device by one.

In some embodiments, when the first differences are continuously obtained, the average value is a same average value.

In some embodiments, before the step of obtaining a measurement value of a target parameter of the aerosol generating device, the method further includes:
heating the aerosol generating device in a second preset duration based on a preset duty cycle;
adjusting output power of the aerosol generating device through incremental PID; and
when a temperature of the aerosol generating device is stable, starting the step of obtaining a measurement value of a target parameter of the aerosol generating device.

According to a second aspect, an embodiment of this application provides an apparatus for counting a number of puffs. The apparatus for counting the number of puffs is used in an aerosol generating device, and includes:
a first obtaining module, configured to obtain a measurement value of a target parameter of the aerosol generating device;
an amplification module, configured to magnify the measurement value and a target value of the target parameter;
a first determining module, configured to determine duty cycle data of the aerosol generating device based on an amplified measurement value and an amplified target value;
a second obtaining module, configured to obtain a real-time value and a current average value of the duty cycle data; and
a second determining module, configured to determine a change in the number of puffs based on the real-time value and the average value.

According to a third aspect, an embodiment of this application provides an aerosol generating device. The aerosol generating device includes at least one processor; and
a memory communicatively connected to the at least one processor, where the memory stores instructions executable for the at least one processor, and the instructions are executed by the at least one processor, to enable the at least one processor to be configured to perform the foregoing method for counting the number of puffs.

In the embodiments of this application, in the method for counting the number of puffs, the measurement value of the target parameter of the aerosol generating device is obtained first. The measurement value and the target value of the target parameter are amplified. Then the duty cycle data of the aerosol generating device is determined based on the amplified measurement value and the amplified target value. The real-time value and the current average value of the duty cycle data are obtained. Finally, the change in the number of puffs is determined based on the real-time value and the average value. According to the method for counting the number of puffs, the measurement value and the target value of the target parameter are simultaneously amplified. Then the duty cycle data of the aerosol generating device is determined based on the amplified measurement value and the amplified target value. In this case, a change in the duty cycle data caused by a puff action is larger, so that sensitivity of capturing the puff action is improved. Therefore, whether a change occurs in the number of puffs can be accurately determined, so that the number of puffs is counted more accurately.

### BRIEF DESCRIPTION OF THE DRAWINGS

One or more embodiments are exemplarily described in the corresponding figures in the accompanying drawings. These exemplary descriptions do not constitute a limitation on the embodiments. In the accompanying drawings, elements having same reference numerals are represented as similar elements. Unless otherwise specified, the accompanying drawings do not constitute a proportion limitation.

FIG. 1a is a schematic diagram of a structure of an aerosol generating device according to an embodiment of this application;

FIG. 1b is a schematic diagram of a circuit structure of an aerosol generating device according to an embodiment of this application;

FIG. 1c is a schematic diagram of a hardware structure of a provided controller;

FIG. 2 is a schematic flowchart of a method for counting a number of puffs according to an embodiment of this application;

FIG. 3 is a schematic flowchart of step S23 in FIG. 2;

FIG. 4 is a schematic diagram of duty cycle data according to an embodiment of this application;

FIG. 5 is a schematic flowchart of a method for counting a number of puffs according to an embodiment of this application;

FIG. 6 is a schematic diagram of duty cycle data according to an embodiment of this application;

FIG. 7 is a schematic flowchart of a method for counting a number of puffs according to an embodiment of this application; and

FIG. 8 is a schematic diagram of a structure of an apparatus for counting a number of puffs according to an embodiment of this application.

### DETAILED DESCRIPTION

To make the objectives, technical solutions, and advantages of this application clearer, the following further describes this application in more details with reference to the accompanying drawings and embodiments. It should be understood that the specific embodiments are merely used to explain this application, but are not intended to limit this application.

An aerosol generating device refers to an apparatus that heats an aerosol generating article to form an inhalable aerosol without burning or igniting the aerosol generating article. The aerosol generating device may also be described as a “tobacco heating product”, a “tobacco heating apparatus”, an “e-cigarette apparatus”, or the like.

The term “aerosol generating article” refers to a material that provides a volatile component in a form of an aerosol when being heated. In some embodiments, the aerosol generating article may include a tobacco component. The tobacco component is any material including tobacco or a derivative thereof. The tobacco component may include one or more of shredded tobacco, tobacco fiber, cut tobacco, compressed tobacco, tobacco stems, reconstituted tobacco, and/or a tobacco extract. In some embodiments, the aerosol generating article may include a tobacco substitute.

Similarly, there is also a so-called e-cigarette apparatus that usually atomizes an aerosol generating article in a liquid form, where a substrate may or may not include nicotine. In another embodiment, the aerosol generating device provides an aerosol or vapor by heating an aerosol generating article in a solid form. In a particular embodiment, the aerosol generating device is the tobacco heating product.

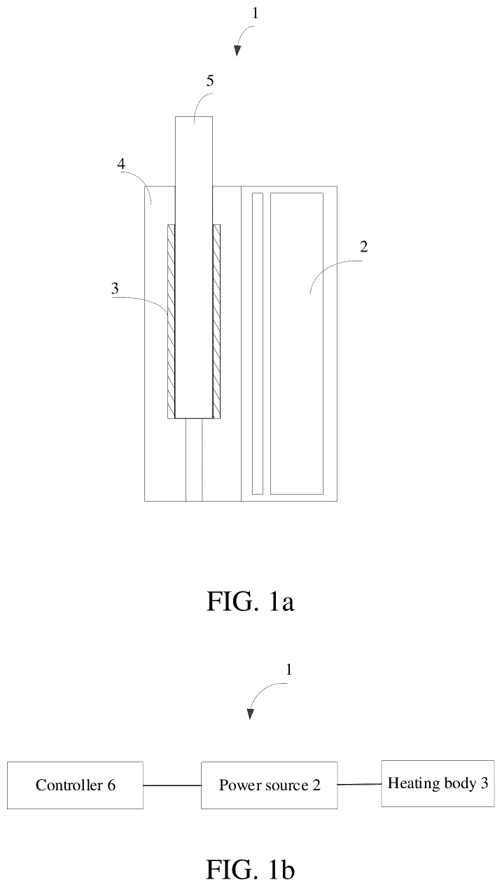

FIG. 1a is a schematic diagram of a structure of an aerosol generating device according to an embodiment of this application, and FIG. 1b is a schematic diagram of a circuit structure of an aerosol generating device according to an embodiment of this application. As shown in FIG. 1a and FIG. 1b, the aerosol generating device 1 includes a power source 2, a heating body 3, a heating chamber 4, an aerosol generating article 5, and a controller 6.

The heating body 3 is configured to heat the aerosol generating article 5 to generate an aerosol. The aerosol generating article 5 may be stored in the heating chamber 4, so that the aerosol generating article 5 can be heated in the heating chamber 4. For example, the heating chamber 4 may be disposed close to the heating body 3, so that heat energy from the heating body 3 heats the aerosol generating article 5 included therein, thereby volatilizing the aerosol without burning the aerosol generating article 5.

The heating body 3 may include a generally cylindrical elongated heating body 3, and the heating chamber 4 is located around a peripheral longitudinal surface of the heating body 3. Therefore, the heating chamber 4 and the aerosol generating article 5 include coaxial layers surrounding the heating body 3. However, in another embodiment, the heating body 3 and the heating chamber 4 of another shape and configuration may be selectively used.

The heating body 3 may be a resistive heating body, which means that when a current is applied to the heating body 3, a resistance in the heating body 3 converts electrical energy into heat energy, and the heat energy heats the aerosol generating article 5. The heating body 3 may be in a form of a resistive wire, a mesh, a coil, and/or a plurality of wires. In some embodiments, the heating body 3 may be a thin-film heater, such as a resistive thin-film heater or an infrared thin-film heater.

The heating body 3 may alternatively be a conductor or a semiconductor, and may include a metal or a metal alloy. The metal is an excellent conductor of electrical energy and heat energy. A suitable metal includes, but is not limited to, copper, aluminum, platinum, tungsten, gold, silver, and titanium. A suitable metal alloy includes, but is not limited to, a nickel-chromium alloy and stainless steel.

The heating body 3 may alternatively be an electromagnet. A changing current flows through the electromagnet to generate a changing magnetic field. One or more eddy currents are generated inside the heating body 3 due to the changing magnetic field, so that the heating body 3 is heated.

The power source 2 is electrically connected to the heating body 3, and is configured to supply power to the heating body 3. The power source may be a power supply that provides electrical power to the heating body 3, such as a lithium-ion battery, a nickel battery, an alkaline battery, and/or other batteries. When being needed, the power source 2 may supply electrical energy to the heating body 3.

The power source 2 is further electrically connected to the controller 6, so that the controller 6 adjusts a magnitude of power outputted by the power source 2. In a preheating stage, the controller 6 controls the power source 2 to supply power to the heating body 3 with high power. Therefore, the heating body 3 rapidly heats the aerosol generating article 5 to a predetermined temperature, to generate an aerosol when a user puffs on. For example, the controller 6 can control the power source 2 to supply the power to the heating body 3 in a full-power mode in the preheating stage. The controller 6 maintains a temperature of the aerosol generating article in a PWM control form after the preheating is completed, to ensure that the aerosol can be generated when the user puffs on. Specifically, the controller 6 adjusts a duty cycle of PWM to adjust the power outputted by the power source 2, thereby maintaining the temperature of the aerosol generating article 5. Therefore, the controller 6 can control a temperature of the heating body 3 by adjusting the magnitude of the power outputted by the power source 2 to the heating body 3, thereby controlling generation of the aerosol. The controller may be disposed at any suitable position in the aerosol generating device 1.

In some embodiments, the controller 6 may be a general-purpose processor, a digital signal processor (DSP), an application-specific integrated circuit (ASIC), a field programmable gate array (FPGA), a single-chip microcomputer, an ARM (Acorn RISC Machine), or another programmable logic device, a discrete gate or transistor logic, a discrete hardware component, or any combination of these components. In addition, the controller 6 may alternatively be any conventional processor, controller, microcontroller, or state machine. The controller 6 may alternatively be implemented as a combination of computing devices, for example, a combination of a DSP and a microprocessor, a plurality of microprocessors, one or more microprocessors in combination with a DSP, and/or any other such configuration. The controller 6 may alternatively be a frequency conversion board or a main control board of a washing machine.

As shown in FIG. 1c, the controller 6 includes: at least one processor 61; and a memory 62 in communication connection with the at least one processor 61. One processor 61 is used as an example in FIG. 1c. The memory 62 stores instructions executable for the at least one processor 61, and the instructions are executed by the at least one processor 61, to enable the at least one processor 61 to be configured to perform a method for counting a number of puffs in the following embodiment. The processor 61 and the memory 62 may be connected through a bus or in another manner. A bus connection is used as an example in FIG. 1c.

The processor 61 may be implemented by using at least one of the following items: an application-specific integrated circuit (ASIC), a digital signal processor (DSP), a digital signal processing device (DSPD), a programmable logic device (PLD), a field programmable gate array (FPGA), a processor, a controller, a microcontroller, a microprocessor, and another electronic unit performing these functions.

The memory 62 includes a high-speed random access memory, and may further include a non-volatile memory, for example, at least one magnetic disk storage device, a flash memory device, or another non-volatile solid-state storage device. In some embodiments, the memory 62 optionally includes memories remotely disposed relative to the processor 61, and these remote memories may be connected to the aerosol generating device through a network. Examples of the network include, but are not limited to, the Internet, an intranet, a local area network, a mobile communications network, and any combination thereof.

The memory 62 is configured to store a non-volatile software program, a non-volatile computer-executable program, and a module, such as program instructions/a unit corresponding to the method/apparatus for counting the number of puffs involved in this specification. The processor 61 operates the non-volatile software program, instructions, and unit stored in the memory 62, to execute functional applications and data processing of the aerosol generating device, that is, implementing the method/apparatus for counting the number of puffs in the following method embodiments.

The controller determines a duty cycle of PWM based a measurement value and a target value of a target parameter of the aerosol generating device, to control power outputted by the power source 2. The target parameter may be a temperature of the heating body, or may be a resistance value of the heating body, and may be set as required.

Using an example in which the target parameter is the temperature of the heating body, the temperature of the heating body is bound to decrease when a user puffs on the aerosol generating device. In this case, the duty cycle of the PWM is changed, to adjust the temperature of the heating body. Therefore, a change in the duty cycle of the PWM is captured, so that a puff action of the user can be captured, thereby counting a number of puffs.

However, a temperature change caused by the puff action is small, and therefore, a change in the duty cycle of the PWM is insensitive. Consequently, capturing of the change in the duty cycle of the PWM is more insensitive, resulting in a failure in accurately determining a change in the number of puffs and accurately counting the number of puffs.

Based on the foregoing reasons, an embodiment of this application provides a method for counting a number of puffs. The method is applied to an aerosol generating device, to improve accuracy of counting the number of puffs.

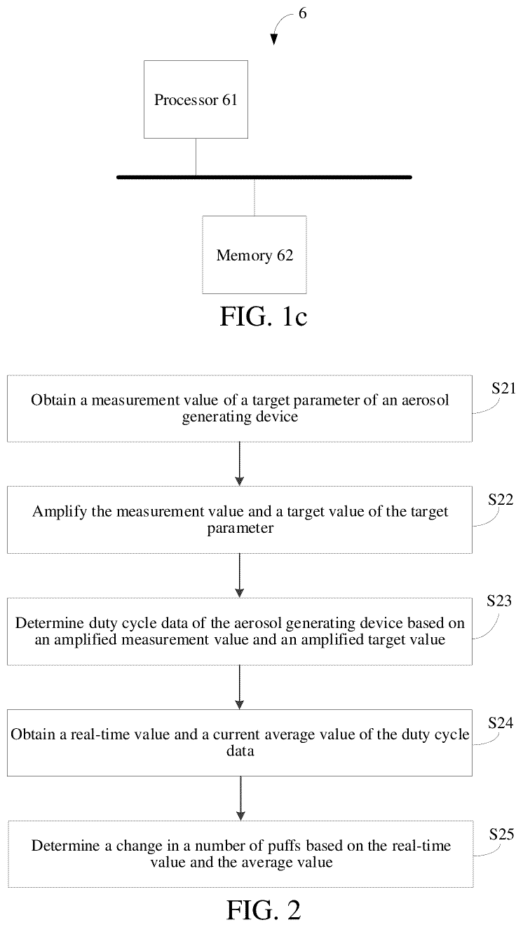

FIG. 2 is a flowchart of a method for counting a number of puffs according to an embodiment of this application. As shown in FIG. 2, the method S200 for counting the number of puffs includes:
S21: Obtain a measurement value of a target parameter of an aerosol generating device.
S22: Amplify the measurement value and a target value of the target parameter.
S23: Determine duty cycle data of the aerosol generating device based on an amplified measurement value and an amplified target value.

Specifically, the target parameter may be a temperature of a heating body. For example, a thermocouple may be attached to the heating body, or an actual temperature of the heating body is directly measurement by using a temperature measurement component such as an infrared temperature measurement component. The actual temperature is a measurement value of the heating body. Meanwhile, a target value of the temperature of the heating body is preset in a controller. The target value is a temperature required for the heating body to heat an aerosol generating article, so that the aerosol generating article is atomized to generate a suitable aerosol when a user puffs on the aerosol generating article.

A PID control algorithm is configured in the controller. The measurement value and the target value of the temperature of the heating body are simultaneously amplified by a preset multiple, and an amplified measurement value and an amplified target value are operated by using the PID control algorithm. According to the PID control algorithm, the duty cycle data may be determined based on a change in a difference between the amplified target value and the amplified measurement value. Because the measurement value and the target value are amplified, the duty cycle data determined by using the PID control algorithm may be conveniently captured. Therefore, when a puff causes a temperature change, the duty cycle data is determined by using the change in the difference between the amplified target value and the amplified measurement value. This facilitates capturing of a change in the duty cycle data caused by the puff, thereby improving possibility and sensitivity of capturing of a puff action, and improving accuracy of subsequent counting the number of puffs.

Alternatively, in some embodiments, according to a TCR (temperature coefficient of resistance) definition formula, the following can be learned:

$$TCR = \frac{R 2 - R 1}{R 1} * \frac{1}{T 2 - T 1} \qquad ( 1 )$$

The temperature of the heating body may alternatively be represented by using a resistance value of the heating body. Therefore, in some embodiments, the target parameter may alternatively be the resistance value of the heating body. In other words, a target value of a resistance of the heating body is a resistance value corresponding to the temperature required for the heating body to heat the aerosol generating article to generate the suitable aerosol. A measurement value of the resistance of the heating body is a real-time value of the heating body in actual work. The real-time value may be obtained by measuring a voltage and a current of the heating body. Then, the measurement value and the target value of the resistance of the heating body are simultaneously amplified by a preset multiple, and an amplified measurement value and an amplified target value are operated by using the PID control algorithm. According to the PID control algorithm, the duty cycle data may be determined based on a change in a difference between the amplified measurement value and the amplified target value.

It should be noted that, the foregoing amplification may be amplification separately performed on the measurement value and the target value by a certain preset coefficient. For example, the measurement value and the target value can be simultaneously amplified by 10000 times. According to the PID control algorithm, the duty cycle data may be determined based on the change in the difference between the amplified measurement value and the amplified target value. Alternatively, in some embodiments, the foregoing amplification may alternatively be amplification performed after a relevant operational relationship is separately performed on the measurement value and the target value. The operational relationship can be obtained based on a relevant formula, for example, the foregoing TCR definition formula.

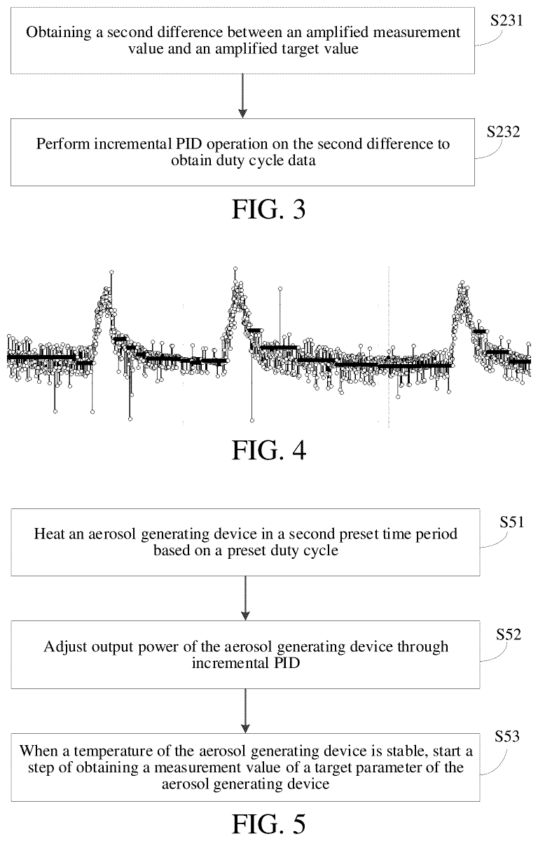

In some embodiments, the duty cycle data is determined through the PID operation. Specifically, as shown in FIG. 3, step S23 includes:
S231: Obtain a second difference between the amplified measurement value and the amplified target value.
S232: Perform incremental PID operation on the second difference to obtain the duty cycle data.

A value obtained through the incremental PID is a change amount relative to a previous value. In this way, the duty cycle data does not suddenly change and is smoother.

S24: Obtain a real-time value and a current average value of the duty cycle data.

The duty cycle data is stored in a preset buffer. A size of the preset buffer is preset and may be set as required. In this embodiment of this application, the preset buffer can store 50 pieces of duty cycle data.

The current average value is determined based on the duty cycle data in the preset buffer only when data in the preset buffer is full. Specifically, whether the data in the preset buffer storing the duty cycle data is full is first determined. If yes, the current average value is determined based on the duty cycle data in the preset buffer, and the data in the preset buffer is cleared. If no, the real-time value of the duty cycle data continues to be stored into the preset buffer.

In addition, an update frequency of the average value is different from an update frequency of the duty cycle data. The update frequency of the average value is less than the update frequency of the real-time value. Specific update frequencies of the average value and the real-time value may be set as required. In this embodiment of this application, the update frequency of the real-time value is 20 milliseconds, and the update frequency of the average value is 1 second.

To prevent an excessively large value or an excessively small value from affecting the average value, median filtering may be performed on the duty cycle data before the average value is calculated. Specifically, the median filtering is first performed on the duty cycle data. Then, an average value of filtered duty cycle data is updated to the current average value. The foregoing steps can enable the obtained average value to be more accurate, reduce interference impact, and further improve accuracy of subsequent counting the number of puffs.

S25: Determine a change in the number of puffs based on the real-time value and the average value.

If a puff action is performed on the aerosol generating device, the real-time value of the duty cycle data changes greatly relative to the current average value. It is determined that the number of puffs that do not burn the device changes when the change in the duty cycle data is captured.

Specifically, a first difference between the real-time value and the average value is obtained, and if an absolute value of the first difference is greater than a first preset threshold, the number of puffs of the aerosol generating device is increased by one. The first preset threshold is set as required, and is related to a product characteristic of the aerosol generating device.

The absolute value of the first difference represents a change degree of the real-time value relative to the average value. It is determined that the number of puffs changes only when the change degree is large. The number of puffs is increased by one, to prevent some normal fluctuations from being mistakenly considered as occurrence of a puff action, thereby further improving the accuracy of counting the number of puffs.

In conclusion, in the method for counting the number of puffs, the measurement value of the target parameter of aerosol generating device is obtained first. The measurement value and the target value of the target parameter are amplified. Then the duty cycle data of the aerosol generating device is determined based on the amplified measurement value and the amplified target value. The real-time value and the current average value of the duty cycle data are obtained. Finally, the change in the number of puffs is determined based on the real-time value and the average value. According to the method for counting the number of puffs, the measurement value and the target value of the target parameter are simultaneously amplified. Then the duty cycle data of the aerosol generating device is determined based on the amplified measurement value and the amplified target value. In this case, the change in the duty cycle data caused by the puff action is larger, so that sensitivity of capturing the puff action is improved. Therefore, whether a change occurs in the number of puffs can be determined more accurately, so that the number of puffs is counted more accurately.

In some embodiments, the average value tracks the real-time value in real time for a period after the number of puffs of the aerosol generating device is increased by one, and then a next step of calculating the average value is entered. In other words, the average value is synchronized with the real-time value for a first preset duration, and then the step of determining whether the data in the preset buffer storing the duty cycle data is full is performed. The first preset duration may be set as required, and in this embodiment of this application, the first preset duration may be 2 seconds.

Using an example in which the number of puffs is 3, duty cycle data is shown in FIG. 4. Hollow dots represent real-time values of the duty cycle data, and horizontal solid lines represent average values of the duty cycle data. It is determined that the number of puffs changes before three wave peaks, and the number of puffs is increased by one. Then, at a wave peak, the average value is equal to the real-time value (in this case, the average value is also represented by a hollow dot). The average value tracks the real-time value in real time for a period, and then a next process of counting the number of puffs is started.

In some embodiments, before the step of obtaining a measurement value of a target parameter of the aerosol generating device, in other words, before a process of counting the number of puffs is started, the aerosol generating device further needs to be preheated. Specifically, as shown in FIG. 5, the method S500 for counting the number of puffs further includes:
S51: Heat the aerosol generating device in a second preset duration based on a preset duty cycle.
S52: Adjust output power of the aerosol generating device through incremental PID.
S53: When a temperature of the aerosol generating device is stable, start the step of obtaining a measurement value of a target parameter of the aerosol generating device.

In a start-up stage, if a difference between the measurement value and the target value is large, the preset duty cycle is output, to heat the aerosol generating device at high power. When the measurement value approaches the target value quickly, the output power is reduced through PID adjustment. The duty cycle data slowly decreases until the temperature of the aerosol generating device is stable. The duty cycle data is automatically adjusted within a fine range.

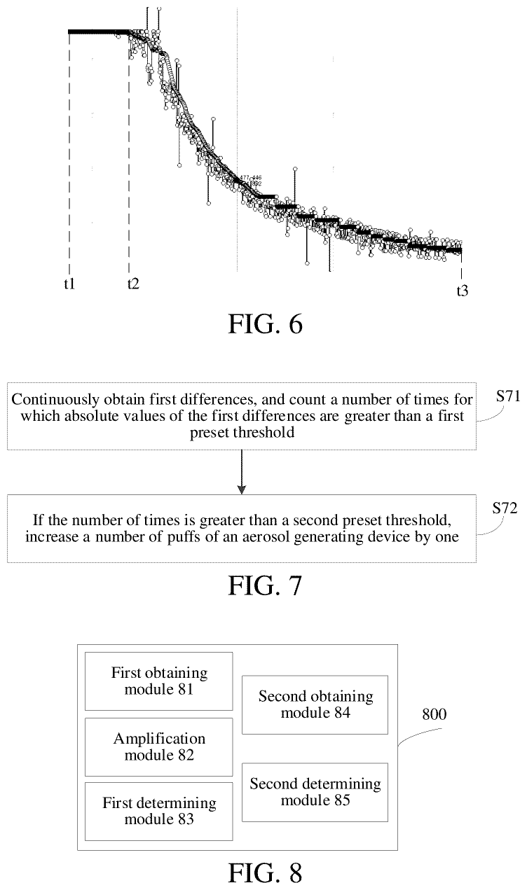

Both the second preset duration and the preset duty cycle may be set as required. In a preheating stage, the duty cycle data is shown in FIG. 6. The duty cycle data is a fixed value that is the preset duty cycle in a stage from t1 to t2, and the duty cycle data gradually decreases until the duty cycle data changes within the fine range in a stage from t2 to t3. Hollow dots represent real-time values of the duty cycle data, and horizontal solid lines represent average values of the duty cycle data.

In some embodiments, the absolute value of the first difference may alternatively be greater than the first preset threshold due to interference, and an error in counting the number of puffs is caused. Therefore, whether the absolute value of the first difference is greater than the first preset threshold needs to be determined for a plurality times, to determine a change in the number of puffs more reliably, so as to improve accuracy of counting the number of puffs. It is determined that the number of puffs changes only when the absolute value of the first difference is greater than the first preset threshold for a plurality times, and the number of puffs is increased by one.

Specifically, when the absolute value of the first difference is greater than the first preset threshold, as shown in FIG. 7, the method S700 for counting the number of puffs further includes:
S71: Continuously obtain first differences, and count a number of times for which absolute values of the first differences are greater than the first preset threshold.
S72: If the number of times is greater than a second preset threshold, increase the number of puffs of the aerosol generating device by one.

When the first differences are continuously obtained, the average value is a same average value, in other words, update of the average value stops. The second preset threshold may be set as required, and is related to a product characteristic of the aerosol generating device.

Therefore, it is determined that the number of puffs changes only when the absolute value of the first difference is greater than the first preset threshold for a plurality of times, and the number of puffs is increased by one, so that an error caused by interference is reduced, thereby further improving reliability and accuracy of counting the number of puffs.

In conclusion, according to the method for counting the number of puffs, the measurement value and the target value of the target parameter are amplified. Then the duty cycle data of the aerosol generating device is determined based on the amplified measurement value and the amplified target value. In this case, the change in the duty cycle data caused by the puff action is larger, so that the sensitivity of capturing the puff action is improved. Therefore, whether a change occurs in the number of puffs can be determined more accurately, so that the number of puffs is counted more accurately.

According to another aspect of the embodiments of this application, an embodiment of this application provides an apparatus for counting a number of puffs. The apparatus is used in an aerosol generating device.

In this embodiment, the apparatus for counting the number of puffs serves as a software system, and is stored in the memory illustrated in FIG. 1c. The apparatus for counting the number of puffs includes a plurality of instructions. The plurality of instructions are stored in the memory. A processor may access the memory and invoke the instructions for execution, to implement control logic of counting the number of puffs.

With reference to FIG. 8, an apparatus 800 for counting a number of puffs includes: a first obtaining module 81, an amplification module 82, a first determining module 83, a second obtaining module 84, and a second determining module 85.

The first obtaining module 81 is configured to obtain a measurement value of a target parameter of the aerosol generating device.

The amplification module 82 is configured to amplify the measurement value and a target value of the target parameter.

The first determining module 83 is configured to determine duty cycle data of the aerosol generating device based on an amplified measurement value and an amplified target value.

The second obtaining module 84 is configured to obtain a real-time value and a current average value of the duty cycle data.

The second determining module 85 is configured to determine a change in the number of puffs based on the real-time value and the average value.

In conclusion, the apparatus for counting the number of puffs amplifies the measurement value and the target value of the target parameter, and determines the duty cycle data of the aerosol generating device based on the amplified measurement value and the amplified target value. In this case, a change in the duty cycle data caused by a puff action is larger, so that sensitivity of capturing the puff action is improved. Therefore, whether a change occurs in the number of puffs can be determined more accurately, so that the number of puffs is counted more accurately.

It should be noted that the foregoing apparatus for counting the number of puffs can execute the method for counting the number of puffs provided in the embodiments of this application, and includes a corresponding functional module and a beneficial effect of executing the method. For technical details that are not described in the embodiment of the apparatus for counting the number of puffs in detail, refer to the method for counting the number of puffs provided in the embodiments of this application.

An embodiment of this application further provides a non-volatile computer storage medium. The computer storage medium stores computer-executable instructions. The computer-executable instructions are executed by one or more processors, for example, the processor 61 shown in FIG. 1c, to enable the one or more processors to perform the method for counting the number of puffs in any one of the foregoing method embodiments.

An embodiment of this application further provides a computer program product. The computer program product includes a computer program stored in a non-volatile computer-readable storage medium. The computer program includes program instructions. When the program instructions are executed by an aerosol generating device, the aerosol generating device is enabled to perform the method for counting the number of puffs in any one of the foregoing method embodiments.

According to the foregoing descriptions of the embodiments, a person of ordinary skill in the art may clearly understand that the embodiments can be implemented by software in combination with a general hardware platform, and certainly can alternatively be implemented by hardware. A person of ordinary skill in the art may understand that all or part of processes in the foregoing method embodiments can be implemented by a computer program instructing relevant hardware. The program may be stored in a computer-readable storage medium. When the program is executed, the processes of the embodiments of the foregoing method may be included. The storage medium may be a magnetic disk, an optical disc, a read-only memory (Read-Only Memory, ROM), a random access memory (Random Access Memory, RAM), or the like.

Finally, it should be noted that the foregoing embodiments are merely used for describing the technical solutions of this application, but are not intended to limit this application. In the concept of this application, technical features of the foregoing embodiments or different embodiments may be combined. Steps may be implemented in any order, and many other changes in different aspects of this application described above exist, which are not provided in detail for simplicity. Although this application is described in detail with reference to the foregoing embodiments, a person of ordinary skill in the art should understand that modifications may still be made to the technical solutions described in the foregoing embodiments, or equivalent replacements are made to some technical features thereof. These modifications or replacements do not cause the essence of the corresponding technical solutions to depart from the scope of the technical solutions of the embodiments of this application.

1. A method for counting a number of puffs, wherein the method is applied to an aerosol generating device, and comprises:
obtaining a measurement value of a target parameter of the aerosol generating device;
amplifying the measurement value and a target value of the target parameter;
determining duty cycle data of the aerosol generating device based on an amplified measurement value and an amplified target value;
obtaining a real-time value and a current average value of the duty cycle data; and
determining a change in the number of puffs based on the real-time value and the average value.

2. The method according to claim 1, wherein the determining a change in the number of puffs based on the real-time value and the average value comprises:
obtaining a first difference between the real-time value and the average value, and if an absolute value of the first difference is greater than a first preset threshold, increasing the number of puffs of the aerosol generating device by one.

3. The method according to claim 1, wherein the determining duty cycle data of the aerosol generating device based on an amplified measurement value and an amplified target value comprises:
obtaining a second difference between the amplified measurement value and the amplified target value; and
performing incremental PID operation on the second difference to obtain the duty cycle data.

4. The method according to claim 2, wherein the method further comprises:
determining whether data in a preset buffer storing the duty cycle data is full; and
if yes, determining the current average value based on the duty cycle data in the preset buffer, and clearing the data in the preset buffer; or
if no, continuing to store the real-time value of the duty cycle data into the preset buffer.

5. The method according to claim 4, wherein the determining the current average value based on the duty cycle data in the preset buffer comprises:
performing median filtering on the duty cycle data; and
updating an average value of filtered duty cycle data to the current average value.

6. The method according to claim 4, wherein after the increasing the number of puffs of the aerosol generating device by one, the method further comprises:
synchronizing the average value and the real-time value for a first preset duration; and
jumping to the step of determining whether data in a preset buffer storing the duty cycle data is full.

7. The method according to claim 4, wherein an update frequency of the average value is less than an update frequency of the real-time value.

8. The method according to claim 2, wherein when the absolute value of the first difference is greater than the first preset threshold, the method further comprises:
continuously obtaining first differences, and counting a number of times for which absolute values of the first differences are greater than the first preset threshold; and
if the number of times is greater than a second preset threshold, increasing the number of puffs of the aerosol generating device by one.

9. The method according to claim 8, wherein when the first differences are continuously obtained, the average value is a same average value.

10. The method according to claim 1, wherein before the step of obtaining a measurement value of a target parameter of the aerosol generating device, the method further comprises:
heating the aerosol generating device in a second preset duration based on a preset duty cycle;
adjusting output power of the aerosol generating device through incremental PID; and
when a temperature of the aerosol generating device is stable, starting the step of obtaining a measurement value of a target parameter of the aerosol generating device.

11. An apparatus for counting a number of puffs, wherein the apparatus for counting the number of puffs is used in an aerosol generating device, and comprises:
a first obtaining module, configured to obtain a measurement value of a target parameter of the aerosol generating device;
an amplification module, configured to amplify the measurement value and a target value of the target parameter;
a first determining module, configured to determine duty cycle data of the aerosol generating device based on an amplified measurement value and an amplified target value;
a second obtaining module, configured to obtain a real-time value and a current average value of the duty cycle data; and
a second determining module, configured to determine a change in the number of puffs based on the real-time value and the average value.

12. An aerosol generating device, wherein the aerosol generating device comprises:
at least one processor; and
a memory communicatively connected to the at least one processor, wherein the memory stores instructions executable for the at least one processor, and the instructions are executed by the at least one processor, to enable the at least one processor to be configured to perform the method for counting a number of puffs according to claim 1.

13. The method according to claim 3, wherein when the absolute value of the first difference is greater than the first preset threshold, the method further comprises:
continuously obtaining first differences, and counting a number of times for which absolute values of the first differences are greater than the first preset threshold; and
if the number of times is greater than a second preset threshold, increasing the number of puffs of the aerosol generating device by one.

14. The method according to claim 4, wherein when the absolute value of the first difference is greater than the first preset threshold, the method further comprises:
continuously obtaining first differences, and counting a number of times for which absolute values of the first differences are greater than the first preset threshold; and
if the number of times is greater than a second preset threshold, increasing the number of puffs of the aerosol generating device by one.

15. The method according to claim 5 wherein when the absolute value of the first difference is greater than the first preset threshold, the method further comprises:
continuously obtaining first differences, and counting a number of times for which absolute values of the first differences are greater than the first preset threshold; and
if the number of times is greater than a second preset threshold, increasing the number of puffs of the aerosol generating device by one.

16. The method according to claim 6, wherein when the absolute value of the first difference is greater than the first preset threshold, the method further comprises:
continuously obtaining first differences, and counting a number of times for which absolute values of the first differences are greater than the first preset threshold; and
if the number of times is greater than a second preset threshold, increasing the number of puffs of the aerosol generating device by one.

17. The method according to claim 7, wherein when the absolute value of the first difference is greater than the first preset threshold, the method further comprises:
continuously obtaining first differences, and counting a number of times for which absolute values of the first differences are greater than the first preset threshold; and
if the number of times is greater than a second preset threshold, increasing the number of puffs of the aerosol generating device by one.
